(19) United States
(12) Patent Application Publication
(10) Pub. No.: US 2018/0239143 A1
(43) Pub. Date: Aug. 23, 2018

(54) PROTECTING A DISPLAY FROM EXTERNAL LIGHT SOURCES

(71) Applicant: Google LLC, Mountain View, CA (US)

(72) Inventor: Erik Goossens, Mountainview, CA (US)

(21) Appl. No.: 15/797,544

(22) Filed: Oct. 30, 2017

Related U.S. Application Data
(60) Provisional application No. 62/461,069, filed on Feb. 20, 2017.

(51) Int. Cl. G02B 27/01; G02B 25/00

(52) U.S. Cl. CPC G02B 27/0172; G02B 2027/0178; G02B 27/0101; G02B 25/001

(57) ABSTRACT

An apparatus such as a head mounted device includes a display to generate an image and an eyepiece lens to focus the image for viewing by a user while the user is wearing the apparatus. A configuration of the apparatus can be modified, in response to the user removing the apparatus, to prevent the eyepiece lens from focusing light on the display. In some cases, the apparatus includes a sensor to generate signals that indicate whether the user is wearing the apparatus. The apparatus can also include a processor to detect that the user has removed the apparatus based on the signals generated by the sensor and to modify the configuration of the apparatus in response to detecting that the user has removed the apparatus. Examples of sensors that can be implemented in the apparatus include a proximity sensor, an accelerometer, and an inertial measurement unit.

### BACKGROUND

Immersive virtual reality (VR) and augmented reality (AR) systems typically utilize a head mounted display (HMD) device that presents stereoscopic imagery to the user so as to give a sense of presence in a three-dimensional (3D) scene. For example, a typical HMD is designed to produce a stereoscopic image over a field-of-view that approaches or is equal to the field-of-view of a human eye, which is approximately 180°. Conventional HMD devices implement either a single flat display that is separated in two independent display regions, one for the left eye and one for the right eye of the user, or a pair of independent flat displays, one for each eye of the user. The conventional HMD further includes a circular lens for each eye so as to focus the entire image of the display into the user's eye. Although the lenses beneficially focus light when the user is wearing the conventional HMD, the focusing effect of the lenses can become detrimental when the user has removed the conventional HMD. For example, if the user places the conventional HMD in a sunlit location, the lenses can focus the sun's rays onto the display (or displays) and the concentrated energy can cause serious damage to the portions of the display (or displays) that are illuminated by the focused sunlight.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example cross-section view of an electronic device configured to provide augmented reality or virtual reality functionality according to some embodiments.

FIG. 2 is a diagram of an optical system that focuses images for viewing by a user according to some embodiments.

FIG. 3 is a diagram of the optical system while exposed to an external light source according to some embodiments.

FIG. 4 illustrates a first situation in which a user is wearing a head mounted display (HMD) to view augmented reality or virtual reality images according to some embodiments.

FIG. 5 illustrates a second situation in which the user has removed the HMD according to some embodiments.

FIG. 6 illustrates an optical system that includes a cover element that is configured to allow light to pass between a display and an eyepiece lens according to some embodiments.

FIG. 7 illustrates the optical system when the cover element is configured to prevent light from passing between the display and the eyepiece lens according to some embodiments.

FIG. 8 illustrates configurations of three cover elements that can selectively allow or prevent passage of light between a display and an eyepiece lens according to some embodiments.

FIG. 9 illustrates configurations of two cover elements that can selectively allow or prevent light from passing between a display and an eyepiece lens according to some embodiments.

FIG. 10 is a diagram of an optical system that includes a light-sensitive element deployed on a cover element according to some embodiments.

FIG. 11 is a diagram that illustrates three configurations of an optical system according to some embodiments.

FIG. 12 is a flow diagram of a method for selectively modifying configuration of a HMD to allow or prevent passage of light between a lens and a display in the HMD according to some embodiments.

### DETAILED DESCRIPTION

The potential for a lens to damage a display in a device such as a head mounted display (HMD) by inadvertently focusing light on the display can be reduced or eliminated by detecting that a user has removed the device based on signals generated by one or more sensors implemented in the device. A configuration of the device is then modified to prevent the lens from focusing light on the display in response to detecting that the user has removed the device. The sensors can include a proximity sensor that determines whether the device is proximate to the user, an accelerometer to detect accelerations that indicate removal of the device, an inertial measurement unit that detects a specific force or angular rate of motion of the device, and the like. Some embodiments of the device include a cover element that selectively prevents light from passing from the lens to the display in response to detecting that the user has removed the device. The cover element can be an iris, set of louvers, a blind, an electrochromic element, a photochromic coating, and the like. Some embodiments of the cover element include a light-sensitive element such as photovoltaic cells or light sensors. The light-sensitive element can be used to generate an alarm in response to detecting sunlight falling on the cover element or to generate an electrical current that can be used to charge a battery or provide power to the device. The alarm can be transmitted to a user equipment (such as a smart phone) by a transceiver implemented in the device. A distance between the lens and the display can be modified in some embodiments of the device, in which case modifying the configuration of the device includes changing the distance between the lens and the display so that the distance is not equal to a focal length of the lens. Some embodiments of the lens can be rotated about an axis of the lens, in which case modifying the configuration of the device includes rotating the lens about the access to prevent the lens from focusing light on the display.

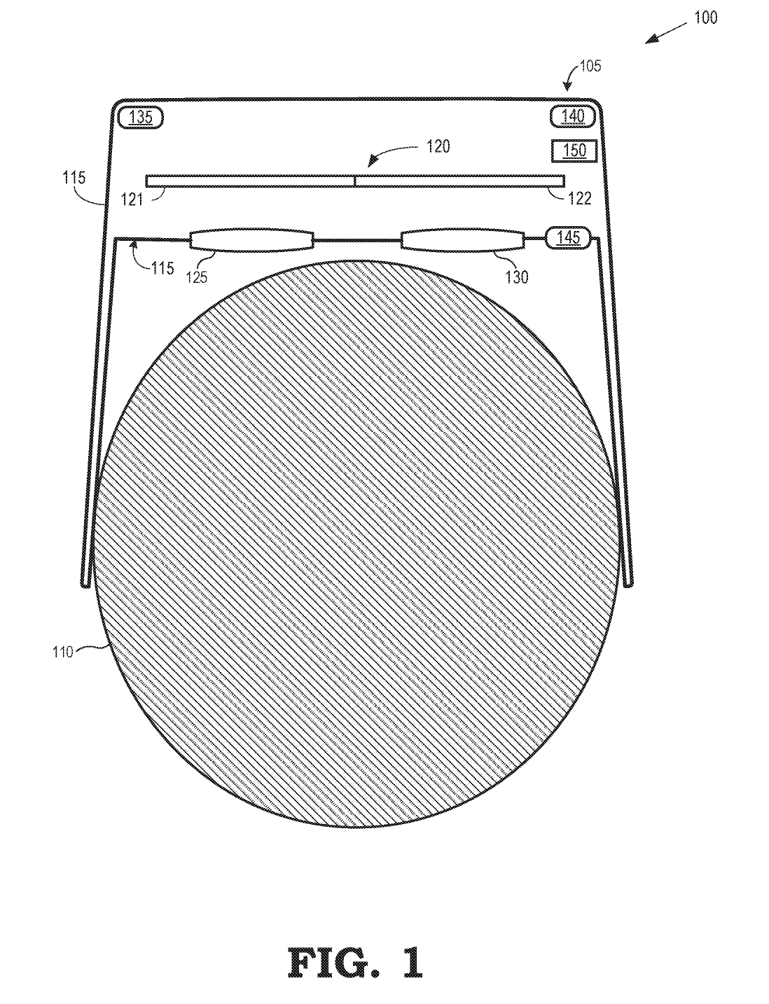

FIG. 1 illustrates an example cross-section view 100 of an electronic device 105 configured to provide augmented reality or virtual reality functionality according to some embodiments. The illustrated embodiment of the electronic device 105 represents an HMD. However, other embodiments of the electronic device 105 can be implemented as (or in conjunction with) other types of portable user devices such as a tablet computer, computing-enabled cellular phone (e.g., a “smartphone”), a notebook computer, a personal digital assistant (PDA), a gaming console system, and the like. In other embodiments, the electronic device 105 can include a fixture device, such as medical imaging equipment, a security imaging sensor system, an industrial robot control system, a drone control system, and the like. For ease of illustration, the electronic device 105 is generally described herein in the example context of an HMD system; however, the electronic device 105 is not limited to these example implementations.

The electronic device 105 is shown in FIG. 1 as being mounted on a head 110 of a user. As illustrated, the electronic device 105 includes a housing 115 that includes a display 120 that generates an image for presentation to the user. In the illustrated embodiment, the display 120 is formed of a left display 121 and a right display 122 that are used to display stereoscopic images to corresponding left eye and right eye. However, in other embodiments, the display 120 is a single monolithic display 120 that generates separate stereoscopic images for display to the left and right eyes. The electronic device 105 also includes eyepiece lenses 125 and 130 disposed in corresponding apertures or other openings in a user-facing surface 135 of the housing 115. The display 120 is disposed distal to the eyepiece lenses 125 and 130 within the housing 115. The eyepiece lens 125 is aligned with the left eye display 121 and the eyepiece lens 130 is aligned with the right eye display 122.

In a stereoscopic display mode, imagery is displayed by the left eye display 121 and viewed by the user's left eye via the eyepiece lens 125. Imagery is concurrently displayed by the right eye display 122 and viewed by the user's right eye via the eyepiece lens 125. The imagery viewed by the left and right eyes is configured to create a stereoscopic view for the user. Some embodiments of the displays 120, 121, 122 are fabricated to include a bezel (not shown in FIG. 1) that encompasses an outer edges of the displays 120, 121, 122. In that case, the lenses 125, 130 or other optical devices are used to combine the images produced by the displays 120, 121, 122 so that bezels around the displays 120, 121, 122 are not seen by the user. Instead, lenses 125, 130 merge the images to appear continuous across boundaries between the displays 120, 121, 122.

In some embodiments, some or all of the electronic components that control and support the operation of the display 120 and other components of the electronic device 105 are implemented within the housing 115. Some embodiments of the housing 115 incorporate one or more sensors that are used to monitor a physical state of the electronic device 105. For example, the housing 115 can incorporate an accelerometer 135 to measure accelerations experienced by the electronic device 105, an inertial measurement unit 140 to measure a specific force or angular rate of motion of the electronic device 105, or a proximity sensor 145 that measures proximity of the electronic device 105 to the head 105 of the user, e.g., by radiating infrared signals and measuring reflected intensities of the infrared signals. Although the housing 115 shown in FIG. 1 includes the accelerometer 135, the inertial measurement unit 140, and the proximity sensor 145, some embodiments of the housing 115 only include a subset of these sensors. The housing 115 can also include other sensors in addition to or instead of the accelerometer 135, the inertial measurement unit 140, or the proximity sensor 145. Furthermore, in some embodiments, multiple accelerometers, inertial measurement units, or proximity sensors can be implemented at different locations within the housing 115.

The housing 115 also includes a processing element 150 that controls the operation and configuration of the electronic device 105. The processing element 150 receives signals from sensors including the accelerometer 135, the inertial measurement unit 140, or the proximity sensor 145. The processing element 150 uses the received signals to control operation or configuration of the electronic device 105. As discussed herein, light incident upon the lenses 125, 130 can be focused on the displays 120, 121, 122, which can cause significant damage to the displays 120, 121, 122. The processing element 150 is therefore able to detect that the user has removed the electronic device 105 based on the signals generated by the accelerometer 135, the inertial measurement unit 140, or the proximity sensor 145 and to modify the configuration of the electronic device 105 in response to detecting that the user has removed the electronic device 105. The configuration is modified to prevent the eyepiece lenses 125, 130 from focusing light from external sources, such as sunlight, on the displays 120, 121, 122. Although the processing element 150 is depicted as a monolithic block for ease of illustration, it will be appreciated that the processing element 150 can be implemented either as a single package or component, or as a set of discrete, interconnected electronic components. Moreover, in some embodiments, some or all of these electronic components may be implemented remote to the housing 115. To illustrate, persons of the processing element 150 can be implemented in a separate device, such as a tablet computer, notebook computer, desktop computer, compute-enabled cellphone, and which is connected to an HMD incorporating the display 120 via one or more wireless or wired connections.

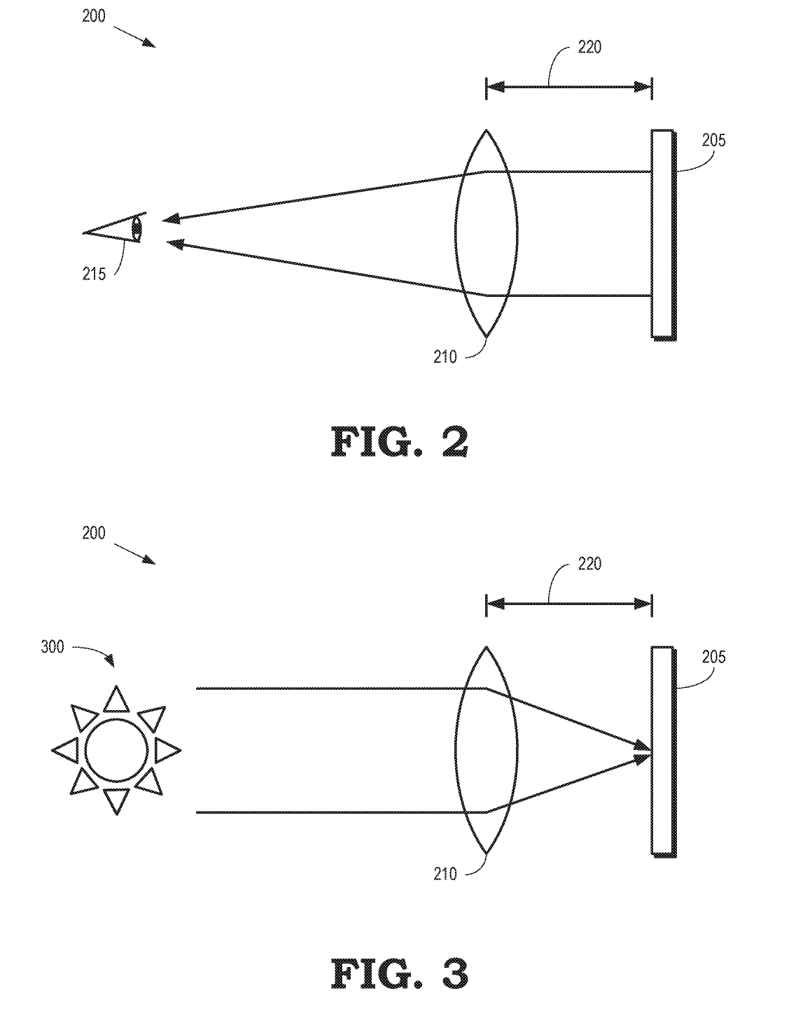

FIG. 2 is a diagram of an optical system 200 that focuses images for viewing by a user according to some embodiments. The optical system 200 includes a display 205 that generates images that are to be viewed by a user. The optical system 200 also includes an eyepiece lens 210 that is used to focus the images generated by the display 205 for viewing by the user. In the illustrated embodiment, optical system 200 is configured so that the eyepiece lens 210 is separated from the display 205 by a distance that focuses some or all of the image generated by the display 205 for viewing by a user, as represented by the eye 215. For example, the eyepiece lens 210 can be displaced from the display 205 by a distance that is equal to a focal length 220 of the eyepiece lens 210.

FIG. 3 is a diagram of the optical system 200 while exposed to an external light source 300 according to some embodiments. In the illustrated embodiment, the external light source 300 is the sun, which illuminates the optical system 200 with sunlight. However, in other embodiments, the external light source 300 can be any other natural or man-made source of light that illuminates the optical system 200. The eyepiece lens 210 is displaced from the display 205 by a distance that focuses sunlight on the display 205. For example, the eyepiece lens 210 can be displaced from the display 205 by a distance that is equal to the focal length 220 of the eyepiece lens 210. Focusing the sunlight on the display 205 concentrates the energy conveyed by the sunlight in small regions of the display 205. The concentrated energy of the sunlight can damage components of the display 205, e.g., by raising the local temperature above a melting point of some or all of the materials used to fabricate the display 205.

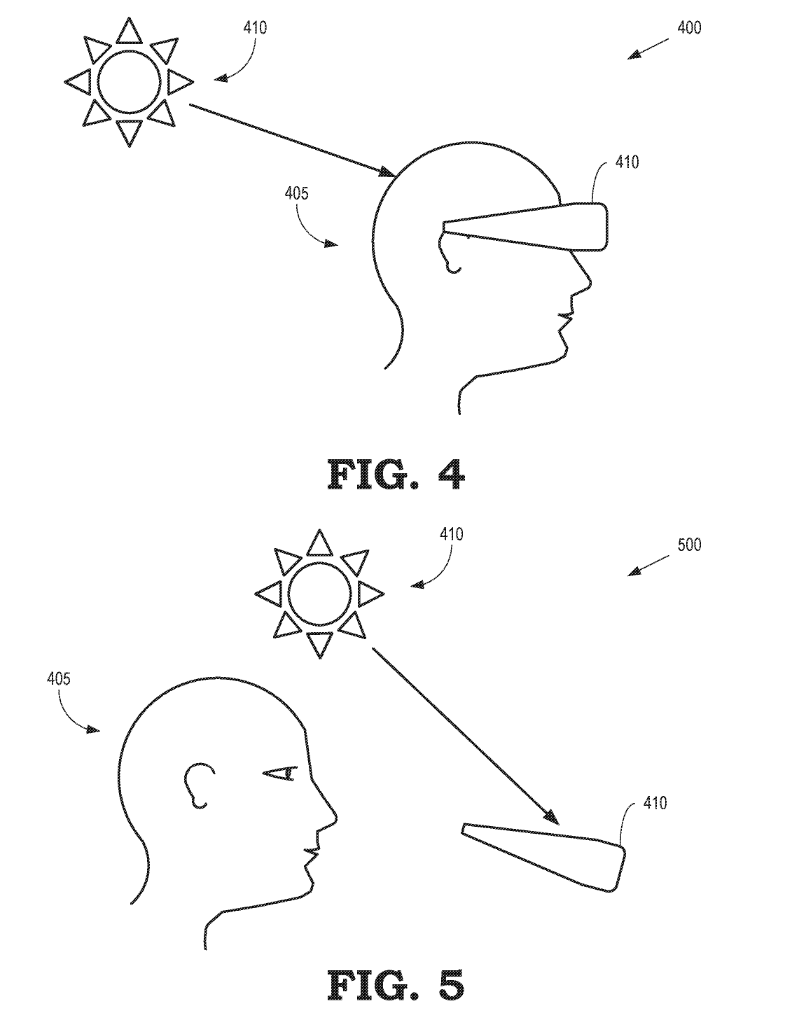

FIG. 4 illustrates a first situation 400 in which a user 405 is wearing an HMD 410 to view augmented reality or virtual reality images according to some embodiments. The HMD 410 is implemented using some embodiments of the electronic device 105 shown in FIG. 1. The situation 400 is illuminated by an external source of light such as the sun 415. A display implemented in the HMD 410 is shielded from the sun 415 by the head of the user 405. Thus, there is little or no danger of the display in the HMD 410 being damaged by sunlight.

FIG. 5 illustrates a second situation 500 in which the user 405 has removed the HMD 410 according to some embodiments. The situation 500 is illuminated by an external source of light such as the sun 415. However, the display implemented in the HMD 410 is no longer shielded from the sun 415 by the head of the user 405. Thus, eyepiece lenses used to focus images generated by the display can be exposed to sunlight and can focus the sunlight to concentrate energy on the display, potentially damaging the display, as discussed herein. A configuration of the HMD 410 is therefore modifiable, in response to the user 405 removing the HMD 410, to prevent the eyepiece lens from focusing light on the display in the HMD 410.

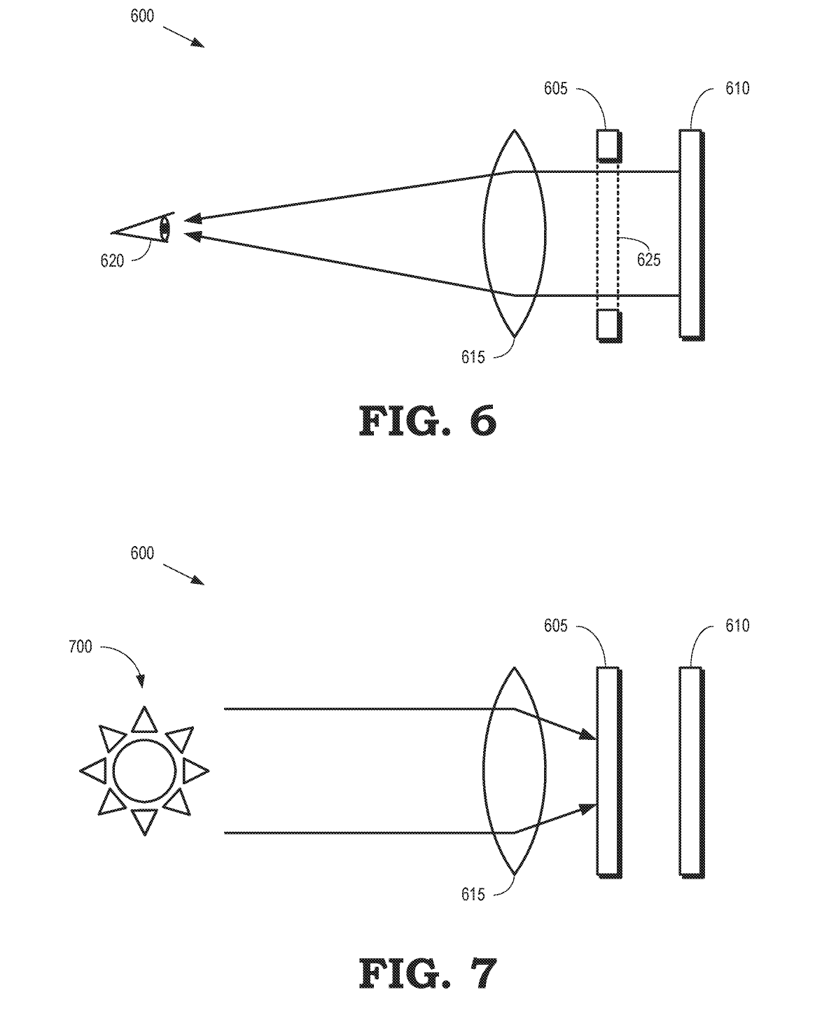

FIG. 6 illustrates an optical system 600 that includes a cover element 605 that is configured to allow light to pass between a display 610 and an eyepiece lens 615 according to some embodiments. The optical system 600 is implemented in some embodiments of the electronic device 105 shown in FIG. 1. In the illustrated embodiment, the optical system 600 is being worn by a user. For example, the optical system 600 can be mounted on the head of the user so that the user is able to see images displayed by the display 610 while wearing the optical system 600 as illustrated in FIG. 4. The optical system 600 is configured so that the eyepiece lens 615 is separated from the display 610 by a distance that focuses some or all of the image generated by the display 610 at an eye 620 of the user. The cover element 605 selectively allows light to pass between the display 610 and the eyepiece lens 615, e.g. through an opening 625 in the cover element 605. For example, the cover element 605 is opened to allow light to pass through the opening 625 in response to one or more sensors implemented in the optical system 600 determining that the user is wearing the optical system 600.

FIG. 7 illustrates the optical system 600 when the cover element 605 is configured to prevent light from passing between the display 610 and the eyepiece lens 615 according to some embodiments. The optical system 600 is implemented in some embodiments of the electronic device 105 shown in FIG. 1. A user has removed the optical system 600 and is no longer wearing the optical system 600, e.g., as illustrated in FIG. 5. In response to detecting removal of the optical system 600, the cover element 605 selectively closes an opening (or modifies an opacity of an electrochromic surface) to prevent light from passing between the display 610 and the eyepiece lens 615. Thus, even though the optical system 600 is exposed to an external source of light, such as the sun 700, the cover element 605 prevents sunlight from impinging on the display 610 while the user is not wearing the optical system 600. Although the cover element 605 is depicted as being deployed between the display 610 and the eyepiece lens 615, some embodiments of the cover element 605 are deployed on the opposite side of the eyepiece lens 615 from the display 610 in a configuration that allows the cover element 605 to selectively allow light to pass to the eyepiece lens 615 or prevent light from falling on the eyepiece lens 615 depending on whether the user is wearing the optical system 600 or not.

Some embodiments of the eyepiece lens 615 include a photochromic coating that is applied to one or more of the surfaces of the eyepiece lens 615. The opacity of the photochromic coating increases (e.g., the photochromic coating darkens) to reduce the amount of light passing through the eyepiece lens 615. For example, the opacity of the photochromic coating can increase in response to an increase in the intensity of ultraviolet (UV) light impinging on the photochromic coating such as an increase in the intensity of UV light due to exposure of the eyepiece lens 615 to direct sunlight. Increasing the opacity of the photochromic coating reduces the amount of energy that passes through the eyepiece lens 615, which reduces the amount of energy that can damage the display 610 or other internal components of the optical system 600.

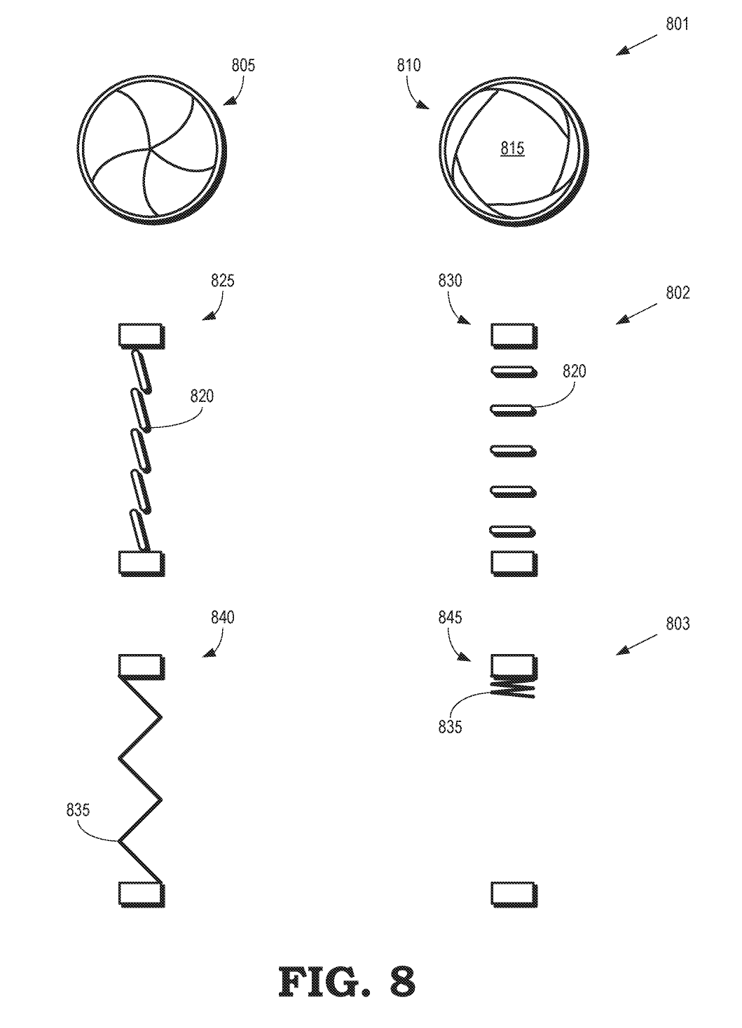

FIG. 8 illustrates configurations of three cover elements 801, 802, 803 that can selectively allow or prevent light from passing between a display and an eyepiece lens according to some embodiments. The cover element 801 is an iris that is closed in a first configuration 805 and opened in a second configuration 810 that includes an opening 815 to allow light to pass through the iris. The cover element 802 includes a set of louvers 820 (only one louver indicated by a reference numeral in the interest of clarity) that are closed in a first configuration 825 and opened in a second configuration 830 to allow light to pass through the louvers 820. The cover element 803 includes a blind 835 that is closed in a first configuration 840 and opened in a second configuration 845 to allow light to pass through the cover element 803.

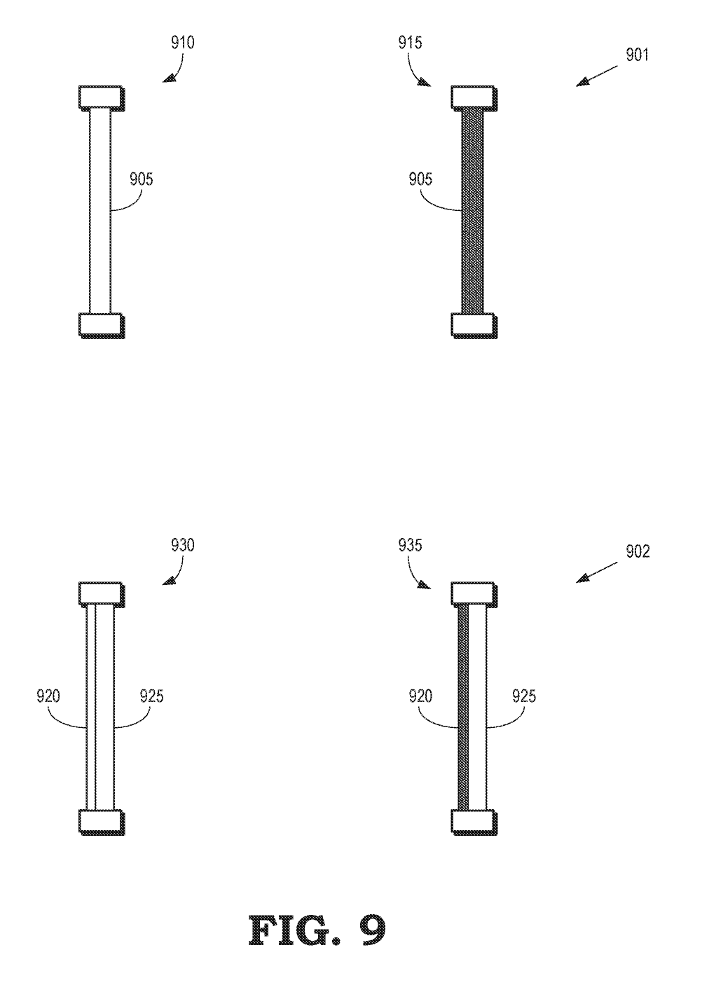

FIG. 9 illustrates configurations of two cover elements 901, 902 that can selectively allow or prevent light from passing between a display and an eyepiece lens according to some embodiments. The cover elements 901, 902 are used to implement some embodiments of the cover element 605 in the optical system 600 shown in FIG. 6 and FIG. 7 using electrochromic elements or films, as discussed below. However, in some embodiments, electrochromic material is used to fabricate some or all of lenses such as the lens 615 shown in FIG. 6 and FIG. 7. For example, the lens can be fabricated of an electrochromic material or an electrochromic film can be applied to a surface of the lens, in which case the lens itself functions as the cover element.

The cover element 901 includes an electrochromic element 905 that is formed of glass, plastic, or other electrochromic material. The transparency or opacity of the electrochromic element 905 is modified in response to changes in an applied voltage. For example, the electrochromic element 905 becomes transparent in response to applying a first voltage, as shown in the first configuration 910 of the cover element 901. In some cases, the first voltage is a nonzero voltage. For another example, the electrochromic element 905 becomes (partially or fully) opaque in response to applying a second voltage, as shown in the second configuration 915 of the cover element 901. In some cases, the second voltage is a zero voltage.

The cover element 902 includes a transparent element 920 and an electrochromic film 925 that is disposed proximate to, adjacent to, or adhered to the transparent element 920. The transparency or opacity of the electrochromic film 925 is modified in response to changes in an applied voltage. For example, the electrochromic film 925 becomes transparent in response to applying a first voltage, as shown in the first configuration 930 of the cover element 902. In some cases, the first voltage is a nonzero voltage. For another example, the electrochromic film 925 becomes (partially or fully) opaque in response to applying a second voltage, as shown in the second configuration 935 of the cover element 902. In some cases, the second voltage is a zero voltage.

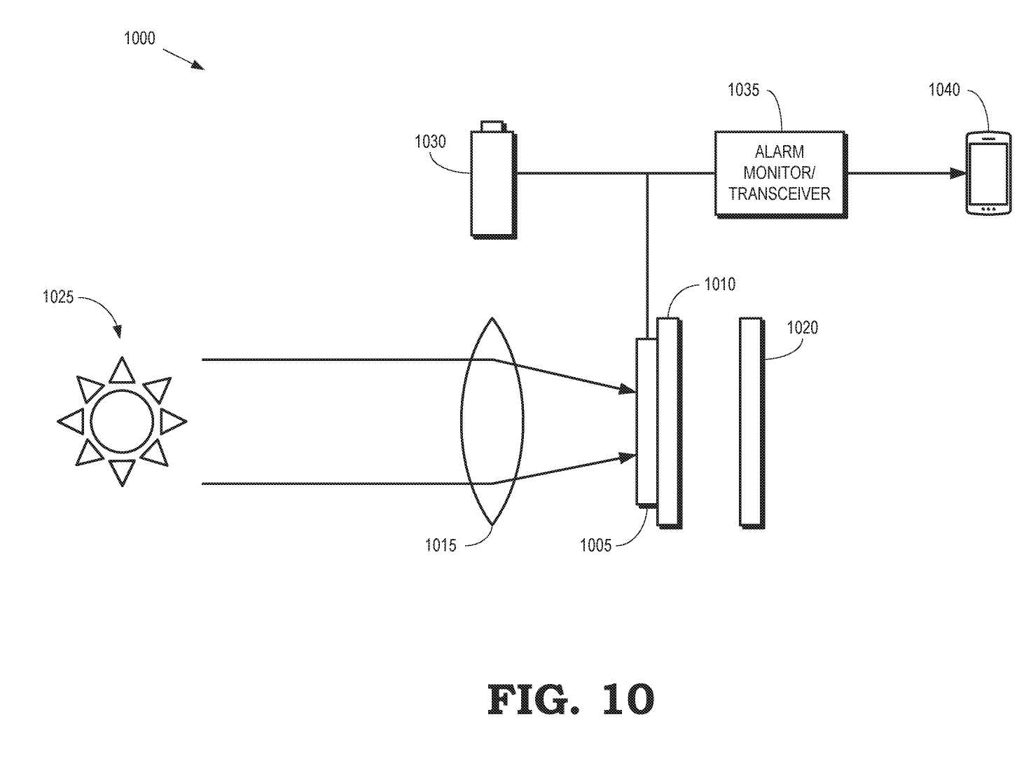

FIG. 10 is a diagram of an optical system 1000 that includes a light-sensitive element 1005 deployed on a cover element 1010 according to some embodiments. The optical system 1000 is implemented in some embodiments of the electronic device 105 shown in FIG. 1. As discussed herein, the cover element 1010 is selectively opened or closed based on the location of the optical system 1000. For example, the cover element 1010 is opened to allow light to pass from an eyepiece lens 1015 to a display 1020 when a user is wearing the optical system 1000 and closed to prevent light from passing from the eyepiece lens 1015 to display 1020 in response to detecting that the user has removed the optical system 1000. In the illustrated embodiment, the user has removed the optical system 1000 and the cover element 1010 is closed. Light from an external light source such as the sun 1025 is not able to impinge upon the display 1020 when the cover element 1010 is closed.

Light from the sun 1025 is (at least partially) focused on the light-sensitive element 1005 by the eyepiece lens 1015. Some embodiments of the light-sensitive element 1005 include a photovoltaic cell. Electrical current generated by the photovoltaic cell is used to charge a battery 1030. The electrical current generated by the photovoltaic cell can also be used to power elements in the optical system 1000 such as the sensors 135, 140, 145 and the processing element 150 shown in FIG. 1. Some embodiments of the light-sensitive element 1005 include a light sensor. An alarm monitor/transceiver 1035 is able to monitor signals generated by the light sensor. If the signal generated by the light sensor indicates that sunlight is falling on the light sensor, the alarm monitor/transceiver 1035 transmits an alarm message to user equipment 1040. The alarm monitor/transceiver 1035 can be configured to transmit the alarm message using wired or wireless connections. Although the light-sensitive element 1005 in the optical system 1000 includes both a photovoltaic cell and a light sensor, some embodiments of the light-sensitive element 1005 only include a photovoltaic cell or a light sensor, but not both.

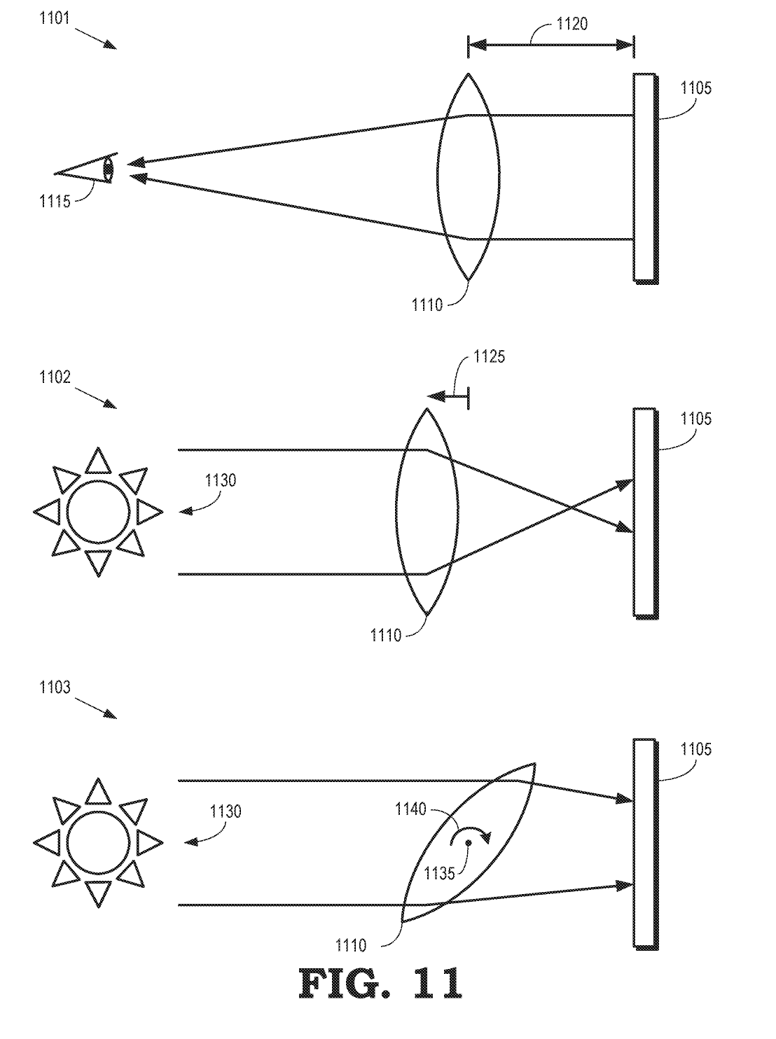

FIG. 11 is a diagram that illustrates three configurations 1101, 1102, 1103 of an optical system according to some embodiments. The optical system is implemented in some embodiments of the electronic device 105 shown in FIG. 1. The first configuration 1101 of the optical system includes a display 1105 that generates images that are to be viewed by a user and an eyepiece lens 1110 that is used to focus the images generated by the display 1105 for viewing by the user.

In the first configuration 1101, the eyepiece lens 1110 is separated from the display 1105 by a distance that focuses some or all of the image generated by the display 1105 for viewing by a user, as represented by the eye 1115. For example, the eyepiece lens 1110 can be displaced from the display 1105 by a distance that is equal to a focal length 1120 of the eyepiece lens 1110. The first configuration 1101 is therefore used when the user is wearing the optical system.

In the second configuration 1102, the eyepiece lens 1110 is configured to allow translational motion relative to the display 1105. The eyepiece lens 1110 is moved relative its position in the first configuration by a distance 1125. Moving the eyepiece lens 1110 by the distance 1125 defocuses light received from an external light source such as the sun 1130 so that the energy in the light received from the sun 1130 is not as concentrated when it impinges upon the display 1105. For example, the eyepiece lens 1110 can be moved further from or closer to the display 1105 so that the distance between the eyepiece lens 1110 and the display 1105 is larger or smaller than the focal length 1120 of the eyepiece lens 1110. Moving the eyepiece lens 1110 by the distance 1125 reduces the potential for damage to the display 1105, e.g., caused by heating of the display 1105 by the concentrated energy of the light received from the sun 1130 and focused by the eyepiece lens 1110. The second configuration 1102 is therefore used when the user is not wearing the optical system.

In the third configuration 1103, the eyepiece lens 1110 is configured for rotational motion about an axis 1135. The eyepiece lens 1110 is rotated about the axis 1135, as indicated by the arrow 1140. Rotating the eyepiece lens 1110 defocuses and redirects light received from the sun 1130 so that the energy in the light received from the sun 1130 is not as concentrated when it impinges upon the display 1105. Rotating the eyepiece lens 1110 about the access 1135 reduces the potential for damage to the display 1105, as discussed herein. The third configuration 1103 is therefore used when the user is not wearing the optical system. Some embodiments of the third configuration 1103 can be implemented in conjunction with some embodiments of the second configuration 1102. For example, the eyepiece lens 1110 can be configured for a combination of translational relative to the display 1105 and rotational motion about one or more axes.

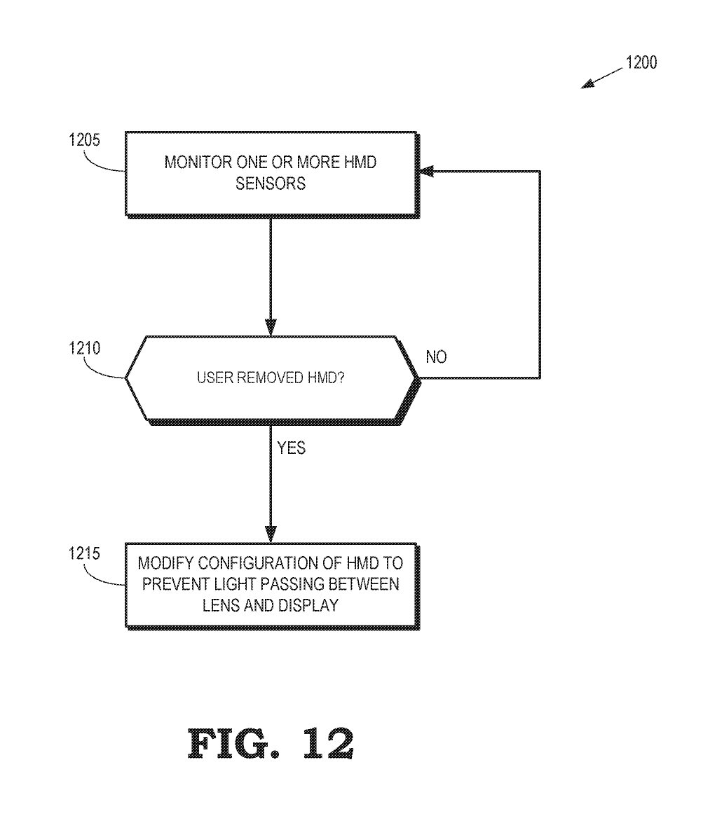

FIG. 12 is a flow diagram of a method 1200 for selectively modifying configuration of an HMD to allow or prevent passage of light between a lens and a display in the HMD according to some embodiments. The method 1200 is implemented in some embodiments of the electronic device 105 shown in FIG. 1. Initially, a user is wearing the HMD to view augmented reality or virtual reality images and the HMD is configured to allow passage of light between the lens and the display in the HMD.

At block 1205, a processor element in the HMD monitors signals generated by one or more HMD sensors. Examples of HMD sensors include accelerometers, inertial measurement units, proximity sensors, and the like.

At decision block 1210, the processor element determines whether the signals received from the HMD sensors indicate that the user has removed the HMD. For example, the processor element can detect a signature in the accelerometer signals that indicates that the user has removed the HMD. For another example, the processor element can detect a signature in the signals that represent a specific force or angular rate of motion of the HMD that indicates that the user has removed the HMD. For yet another example, the proximity sensor can transmit a signal indicating that the HMD is not proximate the user. Combinations of the signals generated by the different sensors can also be used to detect that the user has removed the HMD. As long as the processor element determines that the user has not removed the HMD, the processor element continues to monitor the signals at block 1205. In response to determining that the user has removed the HMD, the method 1200 flows to block 1215.

At block 1215, the processor element generates signals that cause modification to the configuration of the HMD to prevent passage of light between the lens and the display. As discussed herein, the modification to the configuration of the HMD can include closing an opening in a cover element such as an iris, a set of louvers, a blind, modifying a voltage applied to an electrochromic element, and the like. Modification to the configuration of the HMD can also include translational or rotational motion of the lens relative to the display.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
a display to generate an image; and
an eyepiece lens to focus the image for viewing by a user while the user is wearing the apparatus, a configuration of the apparatus being modifiable, in response to the user removing the apparatus, to prevent the eyepiece lens from focusing light on the display.

2. The apparatus of claim 1, further comprising:
a sensor to generate signals that indicate whether the user is wearing the apparatus; and
a processor to detect that the user has removed the apparatus based on the signals generated by the sensor and to modify the configuration of the apparatus in response to detecting that the user has removed the apparatus.

3. The apparatus of claim 2, wherein the sensor comprises at least one of a proximity sensor, an accelerometer, or an inertial measurement unit.

4. The apparatus of claim 1, further comprising:
a cover element that selectively prevents passage of light between the eyepiece lens and the display in response to the user removing the apparatus.

5. The apparatus of claim 4, wherein the cover element comprises at least one of an iris, a set of louvers, a blind, or an electrochromic element.

6. The apparatus of claim 4, further comprising:
a photovoltaic cell deployed on the cover element, wherein the photovoltaic cell is to generate an electrical current in response to light falling on the photovoltaic cell; and
a battery that is chargeable using the electrical current generated by the photovoltaic cell.

7. The apparatus of claim 4, further comprising:
a light sensor deployed on the cover element, wherein the light sensor is to generate a signal in response to detecting incident light; and
a transceiver configured to transmit an alarm message in response to receiving the signal indicating detection of incident light from the light sensor.

8. The apparatus of claim 1, wherein a distance between the display and the eyepiece lens is modifiable, and wherein modifying the configuration of the apparatus comprises modifying the distance between the display and the eyepiece lens in response to the user removing the apparatus.

9. The apparatus of claim 1, wherein the eyepiece lens is rotatable about an axis, and wherein modifying the configuration of the apparatus comprises rotating the eyepiece lens to prevent the eyepiece lens from focusing light on the display.

10. The apparatus of claim 1, wherein the eyepiece lens includes a photochromic coating.

11. The apparatus of claim 1, wherein the apparatus is a head mounted device to present stereoscopic imagery to the user.

12. A method, comprising:
detecting that a user has removed a device comprising a display to generate an image and an eyepiece lens to focus the image for viewing by the user while the user is wearing the device; and
modifying, in response to the user removing the device, a configuration of the device to prevent the eyepiece lens from focusing light on the display.

13. The method of claim 12, further comprising:
generating, using a sensor deployed in the device, signals that indicate whether the user is wearing the device;
detecting that the user has removed the device based on the signals generated by the sensor; and
modifying the configuration of the device in response to detecting that the user has removed the device.

14. The method of claim 13, wherein the sensor comprises at least one of a proximity sensor, an accelerometer, or an inertial measurement unit.

15. The method of claim 12, wherein modifying the configuration of the device comprises modifying a configuration of a cover element to prevent passage of light between the eyepiece lens and the display in response to detecting that the user has removed the device.

16. The method of claim 15, wherein the cover element comprises at least one of an iris, a set of louvers, a blind, or an electrochromic element.

17. The method of claim 15, further comprising:
generating, using a photovoltaic cell deployed on the cover element, an electrical current in response to light falling on the photovoltaic cell; and
charging a battery using the electrical current generated by the photovoltaic cell.

18. The method of claim 15, further comprising:
generating, using a light sensor deployed on the cover element, a signal in response to detecting incident light; and
transmitting an alarm signal in response to receiving the signal indicating detection of incident light from the light sensor.

19. The method of claim 12, wherein modifying the configuration of the device comprises modifying a distance between the display and the eyepiece lens in response to detecting that the user has removed the device.

20. The method of claim 12, wherein modifying the configuration of the device comprises rotating the eyepiece lens to prevent the eyepiece lens from focusing light on the display.

21. The apparatus of claim 12, wherein the apparatus is a head mounted device to present stereoscopic imagery to the user.
